(19) United States
(12) Patent Application Publication
(10) Pub. No.: US 2011/0221158 A1
(43) Pub. Date: Sep. 15, 2011

(54) SUSPENSION STRUT SUPPORT BEARING WITH A SPRING RETAINER AND A RETAINER FOR A LIMIT BUMPER

(75) Inventors: Ralf Stautner, Nurnberg (DE); Andreas Wöllner, Nurnberg (DE)

(73) Assignee: SCHAEFFLER TECHNOLOGIES GMBH & CO. KG, Herzogenaurach (DE)

(21) Appl. No.: 13/038,695

(22) Filed: Mar. 2, 2011

(30) Foreign Application Priority Data
Mar. 15, 2010 (DE) 102010011423.5

(51) Int. Cl. B60G 3/00

(52) U.S. Cl. 280/124.147

(57) ABSTRACT

A suspension strut support bearing with a spring retainer on a housing part made from plastic and a cup-shaped retainer for a limit bumper is provided. The cup-shaped retainer fits at least partially into the housing part in the axial direction and is held on the housing part guided in the radial direction.

### CROSS-REFERENCE TO RELATED APPLICATIONS

This application claims the benefit of German Patent Application No. DE 10 2010 011 423.5, filed Mar. 15, 2010, which is incorporated herein by reference as if fully set forth.

### FIELD OF THE INVENTION

The invention relates to a suspension strut support bearing with a spring retainer on a housing part made from plastic and to a cup-shaped retainer for a limit bumper, wherein the cup-shaped retainer fits at least partially into the housing in the axial direction and is held on the housing guided in the radial direction.

### BACKGROUND

From DE 103 59 638 B3, such a suspension strut support bearing is known that is formed from an upper housing part, a lower housing part, and a rolling bearing encapsulated by the lower and the upper housing parts. The upper housing part is arranged on the side of the car body and the lower housing part is arranged on the side of the road surface. The coil spring of the suspension strut is supported on the lower housing part accordingly.

Suspension strut support bearings are axial supports, because the primary loading directions of the vehicle-side loads against the spring forces are predominantly axial directions that are thus oriented in the same direction as the pivot axis of the suspension strut support bearing. Independent of this situation, however, suspension strut support bearings are often also loaded by radial force components in the radial direction, that is, perpendicular to the pivot axis of the suspension strut support bearing. These radial force components are generated, for example, when the center axis of the coil spring and the pivot axis of the suspension strut support bearing are not aligned. In addition, the force transfer of the spring forces on the spring retainer into the lower housing part is not uniform, which could be dependent, for example, on the position of the end of the coil spring and its torsion characteristics when it is deflected. For hard impacts on the road surface, the coil spring could deflect so much that the limit bumper begins to carry a load. This limit bumper also held on the lower housing of the suspension strut support bearing in the retainer is an arbitrarily shaped rubber pad that is also designated as a bump stop. The impacts absorbed by the bump stop with peak forces definitely up to 60 kN are transferred, in the extreme case, at least partially also into the lower housing of the suspension strut support bearing.

The previously mentioned influences lead to the result that the loads are not transferred uniformly on the periphery of the suspension strut support bearing. Thus there are zones that are highly loaded and less highly loaded in the suspension strut support bearing, wherein the positions of these zones are known to design engineers as a function of the vehicle type. In the past, those skilled in the art have increasingly moved, as described in DE 103 59 638 B3, towards replacing spring retainers made from metal with lower housing parts made from plastics for reasons of costs. The spring retainer and a holder/retainer for the bump stop are integrated in the housing parts. The higher elasticity modulus of the housing parts made from plastic could have the result that such non-uniform loading has a much greater effect than before on non-uniform distributions of the loads in the suspension strut support bearing.

The high loads therefore often resulted in someone skilled in the art reverting to suitable measures like the use of reinforcement made from sheet metal on the lower housing part, in order to avoid impermissible deformation. Such measures lead to increased production costs and thus at least partially cancel out the cost advantages that could be achieved by the use of plastic. In addition, the seats of the retainers for the bump stop made from metal could become loose due to the loads and the different coefficients of thermal expansion in the housing parts made from plastic.

The non-uniform loads prompt someone skilled in the art to shape the more highly loaded zones of the lower housing part differently than the other zones in part through suitable structural measures. Due to these partially non-obvious measures, the suspension strut support bearings must be installed oriented with respect to direction or position. In addition, a position-oriented assembly or positioning could also be required due to other conditions of the arrangement, such as, for example, due to the position of the end of the last winding of the coil spring. Furthermore, a position-oriented direction for automated assembly could be required.

### SUMMARY

The objective of the invention is therefore to create a suspension strut support bearing of the class-forming type that can be produced simply and economically. In addition, the position of the individual components, especially the retainer of the limit bumper in the suspension strut support bearing, should be guaranteed in an operationally reliable way over the entire service life of the vehicle. Furthermore, a position-oriented alignment of the suspension strut support bearing should be ensured during assembly.

This objective is met according to the invention.

The suspension strut support bearing has a spring retainer on a housing part of the suspension strut support bearing. The spring retainer is provided for holding the last winding of the coil spring of a suspension strut. The housing part is made from plastic.

The two axial directions set opposite each other are directions in the same direction as the pivot axis of the suspension strut support bearing. Radial directions are directions projecting at a right angle arbitrarily from the pivot axis.

The housing part is the lower housing part of the suspension strut support bearing, with an upper housing part being allocated to this lower housing part. Between the housing parts, selectively a rolling bearing or a slide bearing is arranged in the axial direction, so that these form a common housing and thus encapsulate the roller or slide bearing. It is also conceivable that, in addition to the axial support, a radial bearing component in the form of a slide bearing or a rolling bearing is arranged in the housing.

The suspension strut support bearing is predominantly designed as an axial support and is a pivot support through which forced movements (torsion) on the support of the car body between this car body and the suspension strut due to pivoting of the two housing parts are as friction free as possible.

A cup-shaped retainer for a limit bumper sits in the housing. The cup-shaped retainer has a base that is perforated and extends essentially in the radial direction and a side wall that projects from the base, predominantly in an axial direction. The base advantageously has an annular disk-shaped construction. Alternatively, the base could also be curved or shaped with beads or shaped differently in some other way. The retainer is advantageously a cold-formed component made from sheet metal, in particular, sheet steel. The side wall advantageously has a hollow cylindrical construction, but could also have cross sections shaped differently in some other way and could be provided with beads or other shaped elements. At the opening of the cup-shaped retainer, at least one edge projects from the side wall, wherein, with this edge, the retainer can be supported, for example, toward the car body on the lower housing part.

The lower housing part has, on the side of the road surface, an opening that is directed in the axial direction, with the retainer with the base being inserted into this opening. The retainer is inserted at least so far into the lower housing that a part of its side wall around the pivot axis is surrounded at least partially by the material of the lower housing part.

So that the seat of the retainer cannot become loose in the lower housing part despite high loads and different thermal expansion of the components, individual holding elements are constructed on the housing part according to the invention. The holding elements are arranged around the retainer. The holding elements engage behind the retainer with a positive fit in at least one axial direction and thus secure the retainer in the lower housing part. The holding elements hold the retainer either in interaction with one edge in the passage opening or secure the retainer in both axial directions on the housing. So that the retainer can be inserted easily and with low resistance into the lower housing part, several individual holding elements are arranged with spacing relative to each other around the pivot axis.

One construction of the invention provides that the retainer has windows formed in the side wall of the retainer around the pivot axis with spacing relative to each other. The windows are passage holes of arbitrary cross section directed in the radial direction. In each of the windows, at least one of the holding elements engages with a positive fit in the radial direction and thus the side wall engages behind at least one edge of the window in at least one direction. Through such an arrangement of the positive-fit connection, a secure solution that saves space especially in the axial directions is created.

The invention further distinguishes itself in that the housing part has at least a first type of holding elements that are flexible in the radial direction and a second type of holding elements that are rigid in the radial direction. Both types of holding elements on the lower housing part extend in the radial direction in the form of radial projections into the opening of the lower housing part and thus are initially in the way of the retainer for insertion into the opening.

Flexible in the radial direction means that, when the retainer is inserted into the lower housing part, the holding elements of the first type deflect elastically in the radial direction so far that these can be pushed between the holding elements of the first type and the second type until the holding elements of both types meet the windows predetermined for them and lock in these windows.

Holding elements of the rigid type are holding elements that are not at all or only barely noticeably flexible in the radial direction compared with the holding elements of the type that are flexible in the radial direction and therefore, these rigid type holding elements could shear off when the retainer is inserted into the opening or must be designed with slight radial extent of offset relative to the retainer. For use of just holding elements of the second type, too little extent of offset could have the result that the seat becomes loose in the case of different thermal expansion of the components. The invention provides, however, a combination of first types and second types of holding elements that are distributed around the pivot axis so that, for assembly of the retainer, the holding elements of the first type yield to a sufficient enough degree in the radial direction, in order to also compensate for the radial overlap of the rigid holding elements.

With one construction of the invention it is provided that the holding elements of the first type are each formed by at least one snap tab that is constructed in most cases on the end on an elastically flexible lever. Each snap tab is connected in an elastically flexible way to the housing part by the lever fixed on one side on the housing. Levers and snap tabs are advantageously made from the same material as the lower housing part and constructed integrally with this part. So that the lever and thus the associated snap tab can deflect freely and elastically in radial directions by the necessary path, this is released relative to the other material of the housing in the direction about the pivot axis and in the radial direction between the lever and housing as well as between the snap tab and housing.

“Released” means that an air gap is formed in the mentioned directions between the lever or the snap tab and the material of the housing. In the radial direction, the air gap must be at least so large that, at least under consideration of all of the tolerances, the associated snap tab can deflect according to its function. Alternatively, the snap tab is completely free from the housing in the radial direction. The air gap directed in the directions about the pivot axis can have an arbitrarily narrow or wide design, because this should ensure only the radial movement of the associated lever with the snap tab.

The advantage of the invention lies in that, in the seat of the retainer in the housing part, sufficient radial extent of offset for secure holding can be guaranteed even for high loads and large play by means of the positive-fit connection between holding elements and the retainer and thus between the lower housing part and the retainer.

As already described in the “Background” section, suspension strut support bearings are not loaded uniformly in any case. There are zones of higher loading and lower loading distributed around the periphery. The advantage of a combination of holding elements of a flexible, elastic type and a rigid type lies in that the holding elements of the second type are constructed in the zones of the housing part that are exposed to high loads. Because these extend merely as radial projections from the material of the housing part, the solid structure of the lower housing part is not weakened.

The elastically flexible construction of the holding elements of the first type necessarily leads to the result that the lower housing part is weakened in these regions. The holding elements of the first type are therefore arranged in zones of the lower housing part that are less affected by high loads.

One construction of the invention provides that the retainer has at least one position orientation element for the oriented installation of the retainer in the housing part. This can then be especially useful when the holding means or the lower housing part do not have symmetric constructions and an oriented assembly is required. In this respect it is further provided that the position orientation element are oriented to one type of the holding elements. This is especially advantageous when the retainer must already have, for various reasons, a position orientation element for the directed assembly of the suspension strut in a suspension strut arrangement. For example, such a position-oriented assembly can ensure that the suspension strut support bearing is directed with the holding elements of the second type in the zones with the higher loads and with the holding elements of the first type in the zones with lower loading.

The position orientation elements are selectively hidden (for example, magnetic) or visible and advantageously formed by at least one flattened section running perpendicular to the axial direction on the cup-shaped retainer. Thus, two of the flattened sections could lie opposite and parallel to each other.

### BRIEF DESCRIPTION OF THE DRAWINGS

The invention will be explained in detail below with reference to an embodiment. In the drawings:

FIG. 1 is a perspective overall view of a suspension strut support bearing,

FIG. 2 is a longitudinal section through the suspension strut support bearing according to FIG. 1 along the pivot axis of the suspension strut support bearing,

FIG. 3 is a view X on the suspension strut support bearing according to FIG. 1,

FIG. 4 is a perspective overall view of the lower housing part of the suspension strut support bearing according to FIG. 1,

FIG. 5 is the view Y on the lower housing part according to FIG. 4,

FIG. 6 is a longitudinal section along the line VI-VI from FIG. 5 of the lower housing part,

FIG. 7 is a perspective overall view of the retainer of the suspension strut support bearing according to FIG. 1, and

FIG. 8 is a section diagram of the retainer according to FIG. 7 in a plane cut perpendicular to the pivot axis.

### DETAILED DESCRIPTION OF THE PREFERRED EMBODIMENTS

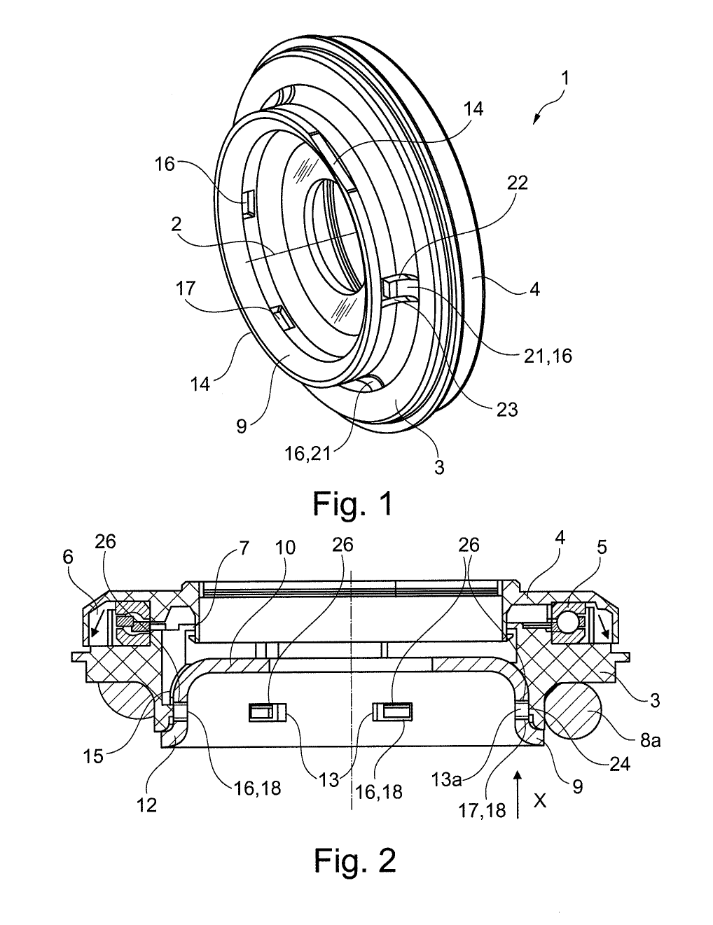

FIG. 1 shows a perspective overall view of a suspension strut support bearing 1 that is illustrated in FIG. 2 in a longitudinal section along the pivot axis 2 of the suspension strut support bearing 1. An upper housing part 4 is snapped together with a lower housing part 3. Between the housing parts 3 and 4 there is a rolling bearing 5 that is arranged in the axial direction and is sealed in the radial direction towards the outside by a seal 6 and in the radial direction towards the inside by a seal 7. The suspension strut support bearing 1 has a spring retainer 8 on the lower housing part 3 for support of a last winding 8a of a coil spring of a not-shown suspension strut, wherein this last winding is shown only in outline. The pivot axis 2 of the suspension strut support bearing 1 is oriented in the axial direction. A cup-shaped retainer 9 for a not-shown limit bumper sits in the lower housing 3.

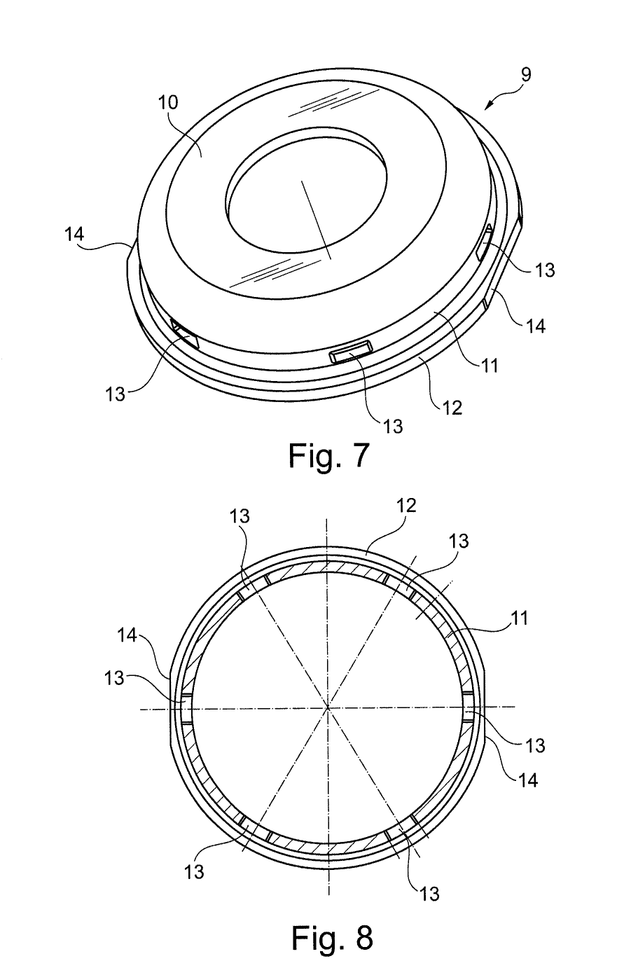

The cup-shaped retainer 9 is shown in FIG. 7 in a perspective overall view and has a base 10 that is perforated and extends essentially in the radial direction and a side wall 11. At the opening of the cup-shaped retainer 9, at least one edge 12 projects from the side wall 11, wherein this edge can be seen especially from FIGS. 7 and 8. FIG. 8 shows a section diagram of the retainer 9 according to FIG. 7 in a plane cut perpendicular to the pivot axis 2. The retainer 9 has windows 13 formed in the side wall 11 on the peripheral side around the pivot axis 2 with spacing relative to each other. The windows 13 are passage holes of rectangular cross section directed in the radial direction.

The retainer 9 has a position orientation element for the oriented installation of the retainer 9 in the lower housing part 3. The position orientation element is formed by two parallel flattened sections 14 running perpendicular to the axial direction at the edge 12 of the retainer 9. Two of the flattened sections 14 lie parallel to each other.

As shown in FIG. 2, the lower housing part 3 has an opening 15 directed in the axial direction, wherein the retainer 9 with the base 10 is inserted into this opening. The retainer 9 is thus inserted into the lower housing part 3 so far that its side wall 11 is surrounded about the pivot axis 2 by the material of the lower housing part 3. In addition, the retainer 9 is supported in the axial direction by the edge 12 on the lower housing part 3.

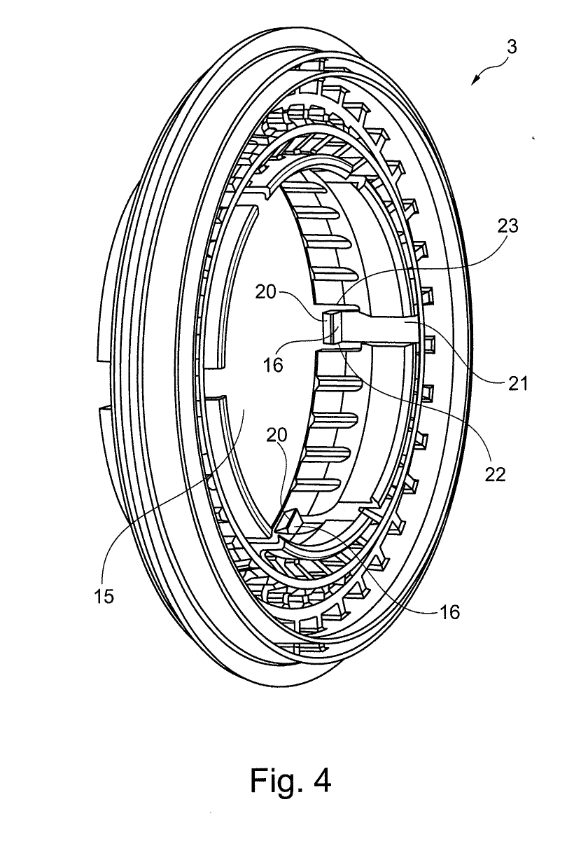

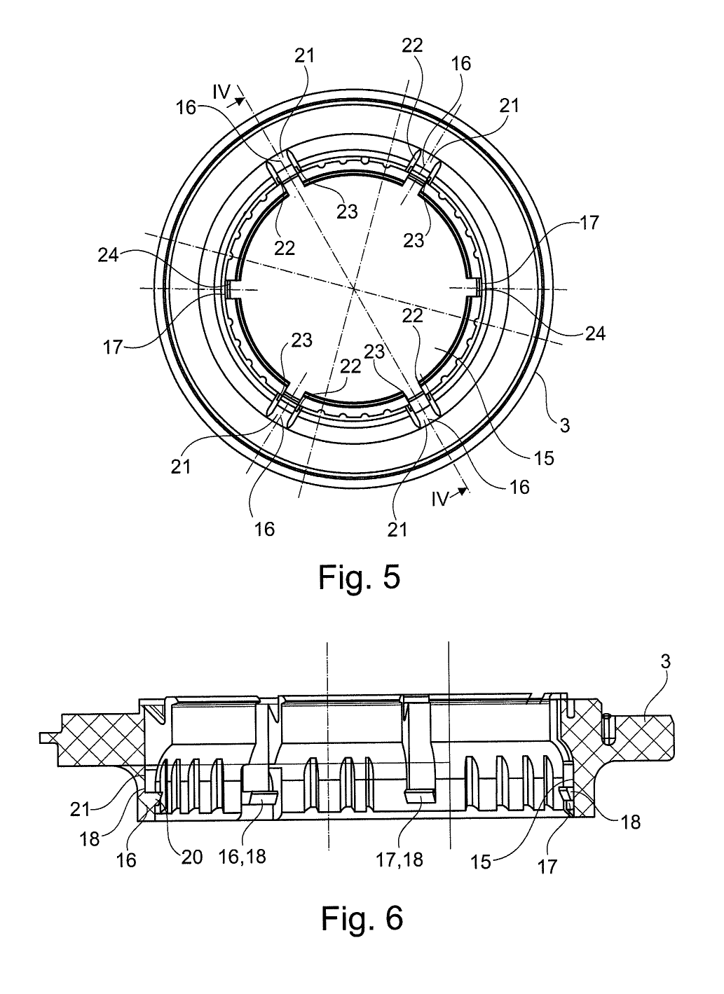

FIG. 4 shows a perspective overall view of the lower housing part 3. FIG. 5 shows the view Y on the lower housing part 3 according to FIG. 4 and FIG. 6 shows a longitudinal section along the line VI-VI from FIG. 5 of the lower housing part 3. On the lower housing part 3, individual holding elements 16 and 17 are constructed.

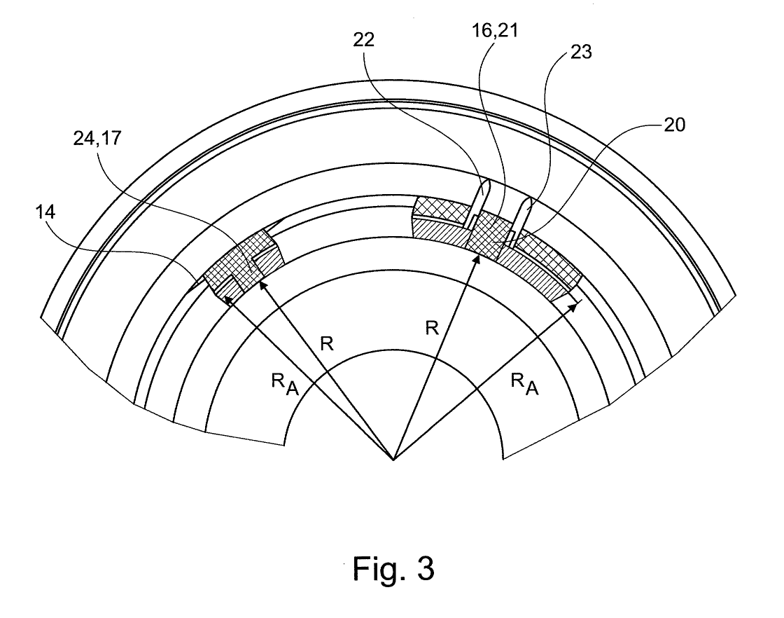

A first type of holding elements 16 has a construction that is flexible in the radial direction. A second type of holding elements 17 is rigid. Both types of the holding elements 16 and 17 on the lower housing part 3 extend in the form of radial projections 18 in the radial direction into the opening 15 of the lower housing part 3 and the retainer 9 is in the way when inserted into the opening 15, because the radial distance R of the inner edges 19 of the associated projections 18 relative to the pivot axis 2 is less than the outer diameter D_{A} of the retainer 9 or the guide diameter D_{A} in the circular opening 15 (FIG. 3).

The first type of holding elements 16 and the second type of holding elements 17 are constructed in the ratio of 1:2 with respect to quantities and are distributed around the pivot axis 3 such that, in this case, two holding elements 17 of the rigid type lie opposite each other on the pivot axis 3 and on the peripheral side, two adjacent, elastically flexible holding elements 16 in-between with uniform spacing relative to each other.

The holding elements 16 of the first type are each formed by at least one snap tab 20 that is constructed on the end of an elastically flexible lever 21. Each snap tab 20 is connected in an elastically flexible way to the lower housing part 3 by the lever 21 fixed on one side on the lower housing part 3. So that the lever 21 and thus the associated snap tab 20 can deflect freely by the necessary path elastically in the radial directions, this is released by air gaps 22 and 23 relative to the other material of the lower housing part 3 in the direction about the pivot axis 2 between the lever 21 and housing part 3 as well as between snap tab 20 and housing part 3. The holding elements 17 of the second type are, in contrast, rigid projections of snap tabs 24 that extend directly from the wall 25 of the lower housing 3.

Referring again to FIGS. 1 and 2, the holding elements 16 and 17 are arranged around the retainer 9. The holding elements 16 and 17 engage behind the retainer 9 with a positive fit in an axial direction, such that one of the holding elements 16 or 17 engages in each of the windows 13 with a positive fit in the radial direction and thus the side wall 11 engages behind an edge 26 of the window 13 in one direction.

The position orientation elements are oriented to the second type of holding elements 17 in that the flattened sections 14 are allocated to windows 13a, wherein the snap tabs 24 lock onto the mounted suspension strut support bearing 1 in these windows.

### REFERENCE SYMBOLS

1 Suspension strut support bearing
2 Pivot axis
3 Lower housing part
4 Upper housing part
5 Rolling bearing
6 Seal
7 Seal
8 Spring retainer
8a Winding
9 Retainer
10 Base
11 Side wall
12 Edge
13 Window
14 Flattened section
15 Opening
16 Holding element
17 Holding element
18 Projection
19 Inner edge
20 Snap tab
21 Lever
22 Air gap
23 Air gap
24 Snap tab
25 Wall
26 Edge

1. Suspension strut support bearing comprising a spring retainer on a housing part made from plastic and a cup-shaped retainer for a limit bumper, the cup-shaped retainer fits at least partially into the housing part in an axial direction and is held on the housing part guided in a radial direction, individual holding elements (16, 17) are formed on the housing part (3), the holding elements (16, 17) are arranged around the cup-shaped retainer (9), and the holding elements (16, 17) engage behind the cup-shaped retainer (9) with a positive fit in an axial direction.

2. Suspension strut support bearing according to claim 1, wherein the retainer (9) has windows (13) directed in the radial direction, at least one of the holding elements (16, 17) engages in the radial direction with a positive fit in one of the windows (13).

3. Suspension strut support bearing according to claim 1, wherein the housing part (3) has at least one first type of the holding elements (16) that are flexible in the radial direction and a second type of the holding elements (17) that are rigid in the radial direction.

4. Suspension strut support bearing according to claim 3, wherein the holding elements (16) of the first type are each formed by at least one snap tab (20) that is constructed on an elastically flexible lever (21), each of the snap tabs (20) is connected to the housing part (21) in an elastically flexible way by the elastically flexible lever (21) fixed on the housing part (3) on one side.

5. Suspension strut support bearing according to claim 4, wherein the lever (21) can move freely in a peripheral direction and in the radial direction relative to the housing part (3).

6. Suspension strut support bearing according to claim 3, wherein the holding element (17) of the second type is a rigid projection (18) extending in the radial direction from the housing part (3).

7. Suspension strut support bearing according to claim 3, wherein the retainer (9) has at least one position orientation element for an oriented installation of the retainer (9) in the housing part.

8. Suspension strut support bearing according to claim 7, wherein the position orientation element is oriented to one type of the holding elements (17).

9. Suspension strut support bearing according to claim 4, wherein the position orientation element is formed by at least one flattened section (14) on the cup-shaped retainer (9) running perpendicular to the axial direction.

10. Suspension strut support bearing according to claim 8, wherein two of the flattened sections (14) are provided and lie opposite and parallel to each other.

11. Suspension strut support bearing according to claim 1, wherein the retainer (9) has at least one position orientation element for the oriented installation of the suspension strut support bearing (1) in a suspension strut arrangement.

12. Suspension strut support bearing according to claim 11, wherein the housing part (3) has at least one first type of the holding elements (16) that are flexible in the radial direction and a second type of the holding elements (17) that are rigid in the radial direction, and the position orientation element is oriented to one type of the holding elements (17) and here the holding elements (16) of the first type are each formed by at least one snap tab (20) that is constructed on an elastically flexible lever (21), and each of the snap tabs (20) is connected to the housing part (3) in an elastically flexible way by the elastically flexible lever (21) fixed on the housing part (3) on one side, and the holding element (17) of the second type is a rigid projection (18) extending in the radial direction from the housing part (3).

13. Suspension strut support bearing according to claim 12, wherein the lever (21) is released in a peripheral direction and in the radial direction relative to the housing part (3).

14. Suspension strut support bearing according to claim 12, wherein the position orientation element is oriented to at least one of the holding elements (17) of the second type.
